(19) United States
(12) Patent Application Publication
(10) Pub. No.: US 2022/0402265 A1
(43) Pub. Date: Dec. 22, 2022

(54) INKJET RECORDING APPARATUS AND INKJET RECORDING METHOD

(71) Applicant: KYOCERA Document Solutions Inc., Osaka (JP)

(72) Inventor: Erika TANAKA, Osaka-shi (JP)

(73) Assignee: KYOCERA Document Solutions Inc., Osaka (JP)

(21) Appl. No.: 17/845,357

(22) Filed: Jun. 21, 2022

(30) Foreign Application Priority Data
Jun. 22, 2021 (JP) 2021-103232

(51) Int. Cl. B41J 2/05; B41J 2/165; B41J 13/00; C09D 11/322; C09D 11/36; C09D 11/38

(52) U.S. Cl. CPC B41J 2/05; B41J 2/16579; B41J 13/0009; C09D 11/322; C09D 11/36; C09D 11/38

(57) ABSTRACT

An inkjet recording apparatus includes a heater and a recording head. The heater is disposed upstream of the recording head in terms of a conveyance direction of a recording medium. The recording medium heated by the heater has a temperature of from 40 to 80° C. The ink contains a pigment, a cellulose derivative, first and second water-soluble organic solvents, and water. The first water-soluble organic solvent is glycol ether. The second water-soluble organic solvent is a water-soluble organic solvent that is not glycol ether. The cellulose derivative has a percentage content of from 0.01 to 0.20% by mass relative to the mass of the ink. The percentage content of the glycol ether is from 6 to 24% by mass relative to the mass of the ink and from 20 to 80% by mass relative to the total mass of the first water-soluble organic solvent and the second water-soluble organic solvent.

### INCORPORATION BY REFERENCE

The present application claims priority under 35 U.S.C. § 119 to Japanese Patent Application No. 2021-103232, filed on Jun. 22, 2021. The contents of this application are incorporated herein by reference in their entirety.

### BACKGROUND

The present disclosure relates to an inkjet recording apparatus and an inkjet recording method.

For label printing and package printing, a low-absorbent recording medium with low water absorbency or a non-absorbent recording medium that does not absorb water may be used. Various inks are studied that hardly bleed when used in image formation on a low-absorbent recording medium or a non-absorbency recording medium. For example, an inkjet ink composition containing a shear thinning agent, a colorant, and a solvent is known.

### SUMMARY

An inkjet recording apparatus according to an aspect of the present disclosure includes a heater that heats a recording medium and a recording head that ejects an ink toward the recording medium. The heater is disposed upstream of the recording head in terms of a conveyance direction of the recording medium. The recording medium heated by the heater has a temperature of at least 40° C. and no greater than 80° C. The ink contains a pigment, a cellulose derivative, a first water-soluble organic solvent, a second water-soluble organic solvent, and water. The first water-soluble organic solvent is glycol ether. The second water-soluble organic solvent is a water-soluble organic solvent that is not glycol ether. The cellulose derivative has a percentage content of at least 0.01% by mass and no greater than 0.20% by mass relative to a mass of the ink. The glycol ether has a percentage content of at least 6% by mass and no greater than 24% by mass relative to the mass of the ink. The glycol ether has a percentage content of at least 20% by mass and no greater than 80% by mass relative to a total mass of the first water-soluble organic solvent and the second water-soluble organic solvent.

An inkjet recording method according to another aspect of the present disclosure includes heating a recording medium and ejecting an ink toward the recording medium. The recording medium is heated before the ink is ejected toward the recording medium. The heated recording medium has a temperature of at least 40° C. and no greater than 80° C. The ink contains a pigment, a cellulose derivative, a first water-soluble organic solvent, a second water-soluble organic solvent, and water. The first water-soluble organic solvent is glycol ether. The second water-soluble organic solvent is a water-soluble organic solvent that is not glycol ether. The cellulose derivative has a percentage content of at least 0.01% by mass and no greater than 0.20% by mass relative to a mass of the ink. The glycol ether has a percentage content of at least 6% by mass and no greater than 24% by mass relative to the mass of the ink. The glycol ether has a percentage content of at least 20% by mass and no greater than 80% by mass relative to a total mass of the first water-soluble organic solvent and the second water-soluble organic solvent.

### BRIEF DESCRIPTION OF THE DRAWINGS

FIG. 1 is a diagram illustrating an example of an inkjet recording apparatus according to a first embodiment of the present disclosure.

FIG. 2 is a diagram illustrating another example of the inkjet recording apparatus according to the first embodiment of the present disclosure.

FIG. 3 is a diagram illustrating still another example of the inkjet recording apparatus according to the first embodiment of the present disclosure.

### DETAILED DESCRIPTION

First of all, the terms used in the present specification will be explained. In the following, the term “(meth)acryl” is used as a generic term for both acryl and methacryl. The term mass average molecular weight means a mass average molecular weight in terms of polystyrene as measured by gel permeation chromatography. The term dynamic surface tension means a surface tension at 50 msec. as measured by the maximum bubble pressure method. A dynamic surface tensiometer (product of KRUSS GmbH, tradename: BP100) may for example be used for dynamic surface tension measurement by the maximum bubble pressure method. The viscosity of an ink is a value as measured in an environment at 25° C. in accordance with the method defined in “the Japanese Industrial Standards (JIS) Z 8803:2011, Methods for viscosity measurement of liquid”. The level of hydrophobicity (or the level of hydrophilicity) can be expressed by a contact angle (wettability of water) of a water drop, for example. The larger the contact angle of a water drop is, the higher the hydrophobicity is. One type of each component described in the present specification may be used independently, or two or more types of the component may be used in combination. The terms used in the present specification have been explained so far.

### First Embodiment: Inkjet Recording Apparatus

The following describes an inkjet recording apparatus according to a first embodiment of the present disclosure. The inkjet recording apparatus according to the first embodiment includes a heater that heats a recording medium and a recording head that ejects an ink toward the recording medium. The heater is disposed upstream of the recording head in terms of a conveyance direction of the recording medium. The recording medium heated by the heater has a temperature of at least 40° C. and no greater than 80° C. The ink is a specific ink described below in [Ink].

In the inkjet recording apparatus with the above configuration, the recording medium is heated (preheated) to a temperature of at least 40° C. and no greater than 80° C. before the ink is ejected from the recording head toward the recording medium. As a result of the recording medium being preheated to a temperature of at least 40° C., the ink is quickly dried by the heated recording medium at and directly after landing of the ink on the recording medium. Accordingly, droplets of the ink are quickly dried after landing thereof and before landing of subsequently ejected droplets of the ink, thereby inhibiting color mixing of the landed ink and the subsequently ejected ink. In the present specification, color mixing means an image defect in which an ink in one color bleeds into an image area of a recording medium printed with an ink in another color. As a result of the recording medium being preheated to a temperature of no greater than 80° C. by contrast, the temperature of the recording head is not excessively raised by the heat of the heated recording medium to inhibit solidification of the ink that results from ink drying in discharge ports of the recording head. Accordingly, ejection performance of the ink in ejection from the recording head improves.

Furthermore, the ink described below in [Ink] hardly bleeds even when an image is formed on a low-absorbent recording medium or a non-absorbent recording medium. In the following “a low-absorbent recording medium and a non-absorbent recording medium” may be referred to collectively as “specific recording medium”. The ink such as above is ejected from the recording head. Therefore, even when an image is formed on the specific recording medium using the inkjet recording apparatus with the above configuration, the ink can hardly bleed and color mixing of the landed ink and the subsequently ejected ink can be inhibited. Furthermore, the ink described below in [Ink] is excellent in ejection performance in ejection from the recording head. The ink such as above is ejected from the recording head. Therefore, inkjet recording apparatus with the above configuration is excellent in ink ejectability by the recording head.

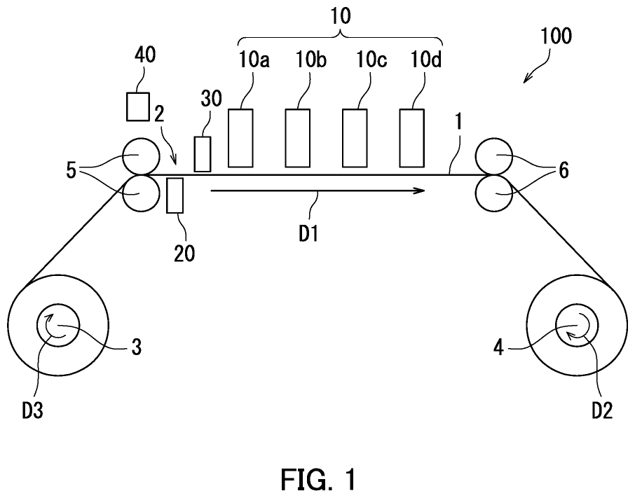

The following describes an inkjet recording apparatus 100, which is an example of the inkjet recording apparatus according to the first embodiment of the present disclosure, with reference to FIG. 1. FIG. 1 illustrates the inkjet recording apparatus 100 according to the first embodiment.

In the inkjet recording apparatus 100, a recording medium 1 is set. The inkjet recording apparatus 100 includes a recording medium conveyance path 2, a feeding rotary shaft 3, a winding rotary shaft 4, a first conveyance roller pair 5, a second conveyance roller pair 6, a first recording head 10a, a second recording head 10b, a third recording head 10c, a fourth recording head 10d, a heater 20, a temperature sensor 30, and a controller 40. In the following, the first recording head 10a, the second recording head 10b, the third recording head 10c, and the fourth recording head 10d may each be referred to as “recording head 10” when there is no need to distinguish thereamong.

The recording medium 1 is rolled in a roll. The recording medium 1 is the specific recording medium, for example. Examples of a low absorbent recording medium with low water absorbency as the specific recording medium include art paper, coated paper, and cast coated paper. Examples of a non-absorbent recording medium that does not absorb water as the specific recording medium include foil paper, synthetic paper, and plastic base materials. Examples of the plastic base materials include polyester (PET) base materials, polypropylene base materials, polystyrene base materials, and polyvinyl chloride base materials. One side or both sides of the specific recording medium may be subjected to surface treatment. Examples of the surface treatment include corona discharge treatment, plasma treatment, and primer treatment.

The rolled recording medium 1 is set to the feeding rotary shaft 3. The feeding rotary shaft 3 feeds the rolled recording medium 1 to the first conveyance roller pair 5.

The first conveyance roller pair 5 conveys the recording medium 1 to the recording medium conveyance path 2.

The recording medium conveyance path 2 is a path that is formed between the first conveyance roller pair 5 and the second conveyance roller pair 6 and through which the recording medium 1 moves. As a result of the recording medium 1 being wound to the winding rotary shaft 4 by rotation of the winding rotary shaft 4, the recording medium 1 is conveyed along the recording medium conveyance path 2 in terms of a conveyance direction (direction indicated by an arrow D1 in FIG. 1) of the recording medium 1. The heater 20, the temperature sensor 30, the first recording head 10a, the second recording head 10b, the third recording head 10c, and the fourth recording head 10d are disposed along the recording medium conveyance path 2 in the stated order from upstream in terms of the conveyance direction of the recording medium 1. The recording heads 10 eject inks toward the recording medium 1 from a plurality of discharge ports (not illustrated) formed in the ejection surface of each recording head 10. For example, the first recording head 10a, the second recording head 10b, the third recording head 10c, and the fourth recording head 10d respectively eject a first ink, a second ink, a third ink, and a fourth ink toward the recording medium 1. The first ink, the second ink, the third ink, and the fourth ink are inks (e.g., a cyan ink, a magenta ink, a yellow ink, and a black ink) mutually different from one another in colors. In the manner described above, a color image is formed on the recording medium 1. No particular limitations are placed on the recording heads 10 and the recording heads 10 may be piezoelectric recording heads or thermal inkjet recording heads.

The heater 20 heats the recording medium 1. The heater 20 is disposed upstream of the recording heads 10 (specifically, the first recording head 10a, for example) in terms of the conveyance direction of the recording medium 1. In the above configuration, the recording medium 1 is heated (preheated) before the recording heads 10 eject the inks toward the recording medium 1. Through preheating, the first ink is quickly dried by the heated recording medium 1 at and directly after landing of the first ink on the recording medium 1 by ejection of the first ink from the first recording head 10a. Accordingly, the first ink is dried quickly after landing thereof and before landing of the second ink subsequently ejected from the second recording head 10b, thereby inhibiting color mixing of the landed first ink and the subsequently ejected second ink. The same effects can be obtained in ejection of the second ink and the third ink and ejection of the third ink and the fourth ink as in ejection of the first ink and the second ink.

The heater 20 is disposed on a side of the reverse side (a side opposite to a side toward which ink is ejected) of the recording medium 1, and heats the recording medium 1 from the side of the reverse side of the recording medium 1. The heater 20 may heat only an image formation area of the recording medium 1 or may heat the entirety of the recording medium 1.

As has been described previously, the heater 20 is disposed upstream of the recording heads 10 in terms of the conveyance direction of the recording medium 1. Furthermore, the heater 20 is disposed on the side of the reverse side of the recording medium 1. As such, the heater 20 is not opposite to the recording head 10. In the above configuration, the recording heads 10 are not heated by the heater 20 to inhibit the ink in the discharge ports of each recording head 10 from being dried and solidified.

The heater 20 heats the recording medium 1 to a preset setting temperature X (a temperature of at least 40° C. and no greater than 80° C.). As a result, the temperature of the recording medium 1 heated by the heater 20 reaches at least 40° C. and no greater than 80° C. In the following, the “temperature of the recording medium 1 heated by the heater 20” may be referred to as “preheating temperature”. When the preheating temperature is less than 40° C., ink drying speed by the heated recording medium 1 decreases. Accordingly, the subsequent ink is ejected before the landed ink dries to cause color mixing of the landed ink and the subsequently ejected ink. When the preheating temperature is greater than 80° C. by contrast, the temperature of each recording head 10 readily increases due to the heat of the heated recording medium 1. Accordingly, the ink in the discharge ports of each recording head 10 is dried and solidified to decrease ejection performance of the ink in ejection from each recording head 10. Preferably, the preheating temperature is at least 50° C. and no greater than 70° C.

The heater 20 heats the recording medium 1 rather than the inks. As such, the ink is quickly dried by the heated recording medium 1 at and directly after landing of the ink. Accordingly, the ink is quickly dried after landing thereof and before landing of the subsequently ejected ink, thereby inhibiting color mixing of the landed ink and the subsequently ejected ink.

The temperature sensor 30 senses the preheating temperature. The temperature sensor 30 is disposed downstream of the heater 20 in terms of the conveyance direction of the recording medium 1. Furthermore, the temperature sensor 30 is disposed upstream of the recording heads 10 (specifically, the first recording head 10a, for example) in terms of the conveyance direction of the recording medium 1.

The temperature sensor 30 is disposed on the side of the front side (side toward which ink is ejected) of the recording medium 1, and senses the temperature of the recording medium 1 from the front side of the recording medium 1. The temperature sensor 30 is located close to the recording medium 1. The distance between the temperature sensor 30 and the recording medium 1 in a direction perpendicular to the conveyance direction of the recording medium 1 is at least 1 mm and no greater than 10 mm, for example. In the recording medium 1, a location (heating point) heated by the heater 20 is at least 0 mm and no greater than 100 mm distant from a location (temperature sensed point) at which the temperature is sensed by the temperature sensor 30, for example. Furthermore, in the recording medium 1, the location (temperature sensed point) at which the temperature is sensed by the temperature sensor 30 is at least 1 mm and no greater than 100 mm distant from a location (ejection point) toward which the ink is ejected by a recording head 10 (e.g., the first recording head 10a), for example. The distance between the heating point and the temperature sensed point and the distance between the temperature sensed point and the ejection point each are a distance in terms of the conveyance direction of the recording medium 1.

The temperature sensor 30 is not opposite to the heater 20. In the above configuration, the temperature sensor 30 can sense the temperature of the recording medium 1 without being affected by the heat of the heater 20.

The second conveyance roller pair 6 conveys to the winding rotary shaft 4 the recording medium 1 on which an image has been formed by ink ejection from the recording heads 10.

The winding rotary shaft 4 winds in a roll the recording medium 1 on which the image has been formed by ink ejection from the recording heads 10. One end of the recording medium 1 is set at the feeding rotary shaft 3 while the other end of the recording medium 1 is set at the winding rotary shaft 4. As a result of transmission of drive power generated by a non-illustrated motor, the winding rotary shaft 4 rotates in a rotational direction thereof (direction indicated by an arrow D2 in FIG. 1). Rotation of the winding rotary shaft 4 winds the recording medium 1 to the winding rotary shaft 4. Winding of the recording medium 1 causes passive rotation of the feeding rotary shaft 3 in a rotational direction thereof (direction indicated by an arrow D3 in FIG. 1) to cause the feeding rotary shaft 3 to feed the recording medium 1.

The controller 40 includes a central processing unit (CPU), read-only memory (ROM), and random-access memory (RAM), for example. The controller 40 controls the entirety of the inkjet recording apparatus 100.

For example, the controller 40 executes feedback control of output of the heater 20 so that the temperature of the recording medium 1 reaches the setting temperature X based on the current temperature of the recording medium 1 sensed by the temperature sensor 30. More specifically, the controller 40 generates a second electric signal indicating a duty ratio according to a difference between the setting temperature X and the temperature of the recording medium 1 that is indicated in a first electric signal input from the temperature sensor 30. The controller 40 inputs the generated second electric signal to the heater 20 to control output of the heater 20.

For example, the controller 40 also controls the rotational speed of the winding rotary shaft 4 and thus the conveyance speed of the recording medium 1 according to a printing rate set by a user. The recording medium 1 is preferably conveyed at a speed of at least 20 m/min. and no greater than 100 m/min. Even when the recording medium 1 is conveyed at a high speed of at least 20 m/min. and no greater than 100 m/min., the inkjet recording apparatus 100 can inhibit color mixing of the inks in the recording medium 1 and have excellent ink ejectability by the recording heads 10.

Note that the ink described below in [Ink] hardly bleed even when an image is formed on the specific recording medium and ejection performance of the ink in ejection from each recording head 10 is excellent. Therefore, the ink may not be a mixed ink obtained by mixing two or more inks (e.g., a main ink and a sub-ink). This can eliminate the need of providing a mixing device for mixing the two or more inks, thereby achieving simplification of the apparatus configuration of the inkjet recording apparatus 100.

The inkjet recording apparatus 100, which is an example of the inkjet recording apparatus according to the first embodiment, has been described so far with reference to FIG. 1. However, the inkjet recording apparatus according to the first embodiment is not limited to the inkjet recording apparatus 100 and can be altered as in the following first to seventh variations.

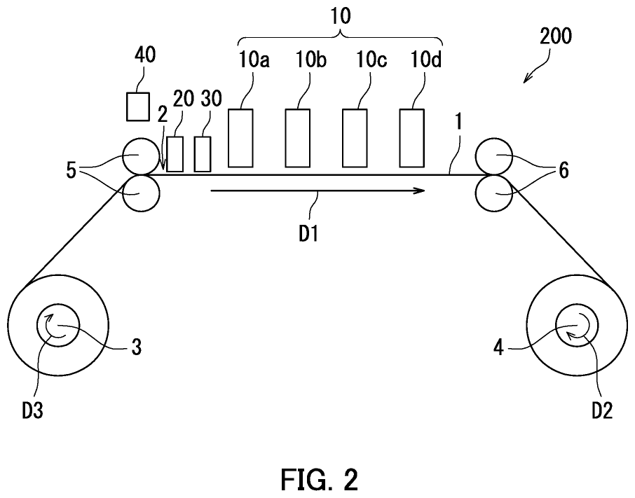

The first variation will be described with reference to FIG. 2. The above-described inkjet recording apparatus 100 heats the recording medium 1 from the side of the reverse side of the recording medium 1 using the heater 20 as an example. However, the recording medium 1 may be heated from the side of the front side thereof using the heater 20, for example, as in an inkjet recording apparatus 200 according to the first variation illustrated in FIG. 2. The heater 20 of the inkjet recording apparatus 200 is disposed on the side of the front side of the recording medium 1 and heats the recording medium 1 from side of the front side thereof.

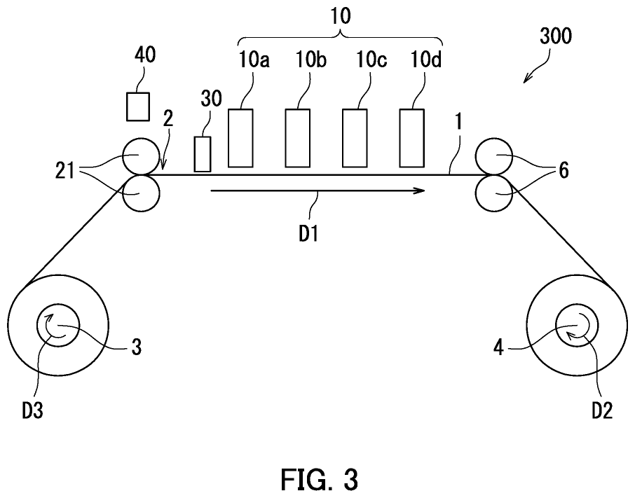

The second variation will be described with reference to FIG. 3. The above inkjet recording apparatus 100 heats the recording medium 1 from side of the reverse side of the recording medium 1 using the heater 20 as an example. However, the recording medium 1 may be heated using a third conveyance roller pair 21 serving also as a heater, for example, as in an inkjet recording apparatus 300 according to the second variation illustrated in FIG. 3. The third conveyance roller pair 21 is disposed upstream of the temperature sensor 30 and the recording heads 10 in terms of the conveyance direction of the recording medium 1. The third conveyance roller pair 21 heats the recording medium 1. A heater (not illustrated) is provided inside one or each of two rollers of the third conveyance roller pair 21. The third conveyance roller pair 21 serves also as a heater. This can eliminate the need of separately providing the heater, thereby achieving simplification of the apparatus configuration. Furthermore, in a case in which the heater is provided inside one or each of the two rollers of the third conveyance roller pair 21, the recording medium 1 is heated from both sides of the front side and the reverse side of the recording medium 1. This can achieve quick heating of the recording medium 1.

The third variation is as follows. The above inkjet recording apparatus 100 uses the recording medium 1 rolled in a roll as an example. However, the recording medium 1 may be a recording medium cut into a specific size (e.g., A4 size), for example.

The fourth variation is as follows. The specific recording medium is used as the recording medium 1 as an example in the above inkjet recording apparatus 100. However, a recording medium (e.g., plain paper, high-quality paper, or cloth) other than the specific recording medium may be used.

The fifth variation is as follows. The above inkjet recording apparatus 100 includes four recording heads 10 of the first recording head 10a, the second recording head 10b, the third recording head 10c, and the fourth recording head 10d as an example. However, the number of the recording heads 10 is not limited specifically. For example, in an inkjet recording apparatus of the fifth variation may include a plurality of (e.g., two, three, or five or more) recording heads 10. The plurality of recording heads 10 eject inks mutually different from one another in color, for example. Alternatively, the inkjet recording apparatus of the fifth variation may include one recording head 10. The ink described below in [Ink] hardly bleed even when an image is formed on the specific recording medium and ejection performance thereof in ejection from the recording head 10 is excellent. Accordingly, in a case of the inkjet recording apparatus of the fifth variation with one recording head 10, occurrence of ink bleeding in formed images can be inhibited and the ink can be favorably ejected from the recording head 10.

The sixth variation is as follows. The above inkjet recording apparatus 100 includes no wiping blades as an example, but may include wiping blades for wiping the ejection surfaces of the respective recording heads 10.

The seventh variation is as follows. The above inkjet recording apparatus 100 includes neither a conveyance plate nor a conveyance belt as an example. However, a conveyance plate or a conveyance belt may be provided for conveying the recording medium 1. The conveyance plate and the conveyance belt may be disposed in contact with or close to the heater 20.

The inkjet recording apparatus according to the first embodiment has been described so far with reference to FIGS. 1 to 3.

### Second Embodiment: Inkjet Recording Method

An inkjet recording method according to a second embodiment of the present disclosure will be described next with reference to FIGS. 1 to 3. The inkjet recording method according to the second embodiment is implemented by the inkjet recording apparatus 100, 200, or 300 according to the first embodiment. As such, in the inkjet recording method according to the second embodiment, color mixing of the inks can be inhibited even when an image is formed on the specific recording medium, and ejection performance of the ink in ejection from each recording head 10 can be excellent.

The inkjet recording method according to the second embodiment of the present disclosure includes heating (a heating process) the recording medium 1 and ejecting (an ejection process) an ink toward the recording medium 1. The recording medium 1 is heated before the ink is ejected toward the recording medium 1. The heated recording medium 1 has a temperature of at least 40° C. and no greater than 80° C. The ink is the ink described below in [Ink]. In the heating process, the recording medium 1 is heated by the heater 20. In the ejection process, the ink is ejected from each recording head 10 toward the recording medium 1. The inkjet recording method according to the second embodiment has been described so far with reference to FIGS. 1 to 3.

[Ink]

The following describes the ink used in the inkjet recording apparatus according to the first embodiment and the inkjet recording method according to the second embodiment. The ink contains a pigment, a cellulose derivative, a first water-soluble organic solvent, a second water-soluble organic solvent, and water. The first water-soluble organic solvent is glycol ether. The second water-soluble organic solvent is a water-soluble organic solvent that is not glycol ether. The cellulose derivative has a percentage content of at least 0.01% by mass and no greater than 0.20% by mass relative to the mass of the ink. The glycol ether has a percentage content of at least 6% by mass and no greater than 24% by mass relative to the mass of the ink. The glycol ether has a percentage content of at least 20% by mass and no greater than 80% by mass relative to a total mass of the first water-soluble organic solvent and the second water-soluble organic solvent.

The ink is a water-based ink containing water. The specific recording medium has a low water absorbency or does not absorb water. As such, an image printed on the specific recording medium with a water-based ink may be blurred due to ink bleeding. However, the ink with the above features can be favorably inhibited from bleeding even in an image printed on the specific recording medium. Furthermore, the ink with the above features is excellent in ejection performance in ejection from the discharge ports of each recording head.

(Cellulose Derivative)

As a result of the ink containing a cellulose derivative, the ink landed on the specific recording medium can be increased in viscosity. Accordingly, coalescence of ink droplets of the ink landed on the specific recording medium can be inhibited. As a result, high-quality images with less blurring can be obtained.

As has been described previously, the percentage content of the cellulose derivative is at least 0.01% by mass and no greater than 0.20% by mass relative to the mass of the ink. When the percentage content of the cellulose derivative is less than 0.01% by mass relative to the mass of the ink, the viscosity of the ink landed on the specific recording medium insufficiently increases to cause coalescence of ink droplets of the ink, thereby leading to ink bleeding in the specific recording medium. When the percentage content of the cellulose derivative is greater than 0.20% by mass relative to the mass of the ink, the viscosity of the ink may become excessively high to decrease ejection performance of the ink in ejection from the discharge ports of each recording head. When the percentage content of the cellulose derivative is at least 0.01% by mass and no greater than 0.20% by mass relative to the mass of the ink, the ink can be stably ejected from the discharge ports of each recording head and coalescence of ink droplets of the ink landed on the specific recording medium can be inhibited. Accordingly, high-quality images with less blurring can be easily obtained.

Examples of the cellulose derivative include sodium salt of carboxymethylcellulose (also referred to below as sodium carboxymethylcellulose), calcium salt of carboxymethylcellulose, methylcellulose, hydroxipropylmethylcellulose, hydroxypropylcellulse, ethylcellulose, and methylcellulose.

From the viewpoint of ensuring ejection performance of the ink in ejection from each recording head, the cellulose derivative is preferably sodium carboxymethylcellulose. Carboxymethylcellulose has a structure in which a carboxymethyl group is ether bonded to a hydroxyl group in an anhydrous glucose unit of cellulose (in other words, structure in which a hydrogen atom of a hydroxyl group in an anhydrous glucose unit is substituted with a carboxymethyl group).

From the viewpoint of ensuring ejection performance of the ink in ejection from each recording head, the degree of etherification of sodium carboxymethylcellulose is preferably at least 0.6 and no greater than 1.5, and more preferably at least 0.8 and less than 1.0 or at least 1.0 and no greater than 1.5. In the present specification, the degree of etherification of sodium carboxymethylcellulose means an average of the numbers of moles of carboxymethyl group per 1 mol of anhydrous glucose unit.

Sodium carboxymethylcellulose may be a commercially available sodium carboxymethylcellulose. Examples of a commercially available sodium carboxymethylcellulose with a degree of etherification of at least 0.6 and no greater than 1.5 includes “CMC DAICEL (registered Japanese trademark) 1120, CMC DAICEL 1130, CMC DAICEL 1140, CMC DAICEL 1150, CMC DAICEL 1220, CMC DAICEL 1240, CMC DAICEL 1250, CMC DAICEL 1260, CMC DAICEL 1330, and CMC DAICEL 1350 each produced by Daicel Miraizu Ltd.

Preferably, a 1%-by-mass aqueous solution of sodium carboxymethylcellulose at 25° C. has a viscosity of at least 10 mPa·s and no greater than 300 mPa·s. As a result of the viscosity of the 1%-by-mass aqueous solution of sodium carboxymethylcellulose at 25° C. being set within the above range, the viscosity of the ink can be easily adjusted to a viscosity suitable for inkjet recording. For measurement of the viscosity of the 1%-by-mass aqueous solution of sodium carboxymethylcellulose, a vibration viscometer (product of SEKONIC COOPERATION, product name: VM-10A-L) can be used, for example.

(First Water-Soluble Organic Solvent)

The first water-soluble organic solvent is glycol ether. Glycol ether has relatively high hydrophobicity. As a result of the ink containing glycol ether with high hydrophobicity, the ink readily wets the specific recording medium that has low water absorbency or that does not absorb water. Accordingly, ink bleeding can be inhibited even in image formation on the specific recording medium.

The glycol ether is preferably alkyl ether with a carbon number of at least 1 and no greater than 6 of alkylene glycol with a carbon number of at least 2 and no greater than 6, and more preferably alkyl ether with a carbon number of at least 1 and no greater than 4 of alkylene glycol with a carbon number of at least 2 and no greater than 3. Further preferable examples of the glycol ether include at least one (e.g., one) selected from the group consisting of propylene glycol monomethyl ether, propylene glycol monopropyl ether, dipropylene glycol monomethyl ether, dipropylene glycol monopropyl ether, and triethylene glycol monobutyl ether.

From the viewpoint of increasing wettability of the ink to the specific recording medium and inhibiting ink bleeding in an image formed on the specific recording medium, the glycol ether preferably has a percentage content of at least 6% by mass and no greater than 24% by mass relative the mass of the ink. As a result of the percentage content of the glycol ether being set to at least 6% by mass relative to the mass of the ink, hydrophobicity of the ink can be appropriately high. Accordingly, ink repelling hardly occurs even on an image formed on the specific recording medium. The percentage content of the glycol ether is preferably at least 10% by mass and no greater than 24% by mass relative to the mass of the ink.

From the viewpoint of favorably drying the ink landed on the specific recording medium, the glycol ether has a percentage content of at least 20% by mass and no greater than 80% by mass relative to the total mass of the first water-soluble organic solvent and the second water-soluble organic solvent. This can achieve favorable drying of the ink to inhibit coalescence of ink droplets of the ink landed on the specific recording medium. Accordingly, high-quality images with less blurring can be obtained. From the same viewpoint as above, the glycol ether has a percentage content of preferably at least 30% by mass and no greater than 80% by mass relative to the total mass of the first water-soluble organic solvent and the second water-soluble organic solvent, and more preferably at least 40% by mass and no greater than 60% by mass.

(Second Water-Soluble Organic Solvent)

The second water-soluble organic solvent is a water-soluble organic solvent that is not glycol ether. Examples of the second water-soluble organic solvent include 1,2-propanediol, 3-methyl-1,3-butanediol, 1,2-pentanediol, 2-methyl-1,3-propanediol, 1,3-propanediol, dipropylene glycol, 1,5-pentanediol, 3-methyl-1,5-pentanediol, ethylene glycol, 2-pyrrolidone, and glycerin.

The second water-soluble organic solvent is preferably alkane polyol or polyalkylene glycol, more preferably alkanediol or dialkylene glycol, and further preferably alkanediol with a carbon number of at least 3 and no greater than 6 or dialkylene glycol with a carbon number of at least 4 and no greater than 6. The second water-soluble organic solvent is still further preferably at least one (e.g., one) selected from the group consisting of 1,2-propanediol, 3-methyl-1,3-butanediol, 1,2-pentanediol, 2-methyl-1,3-propanediol, 1,3-propanediol, 1,5-pentanediol, and 3-methyl-1,5-pentanediol.

(Water)

The water contained in the ink is preferably ion exchange water (deionized water). From the viewpoint of favorably drying the ink landed on the specific recording medium, the water has a percentage content of preferably at least 45% by mass relative to the mass of the ink, more preferably at least 50% by mass, and further preferably at least 55% by mass. No particular limitations are placed on the upper limit of the percentage content of the water, and the percentage content of the water is for example no greater than 70% by mass relative to the mass of the ink.

(Pigment)

No particular limitations are placed on the pigment contained in the ink, and examples of the pigment include black pigments, cyan pigments, magenta pigments, yellow pigments, white pigments, and pigments (also referred to below as additional pigments) other than these.

An example of the black pigments is carbon black produced by a furnace method or a channel method. Examples of commercially available carbon black include RAVEN (registered Japanese trademark) 5000 ULTRA II, RAVEN 3500, RAVEN 2000, RAVEN 1255, RAVEN 1250, RAVEN 1200, RAVEN 1190 ULTRA, RAVEN 1170, RAVEN 1080 ULTRA, and RAVEN 1060 ULTRA each produced by Aditya Birla Chemicals LTD. Other examples of the commercially available carbon black include MONARCH (registered Japanese trademark) 1300, MONARCH 1000, MONARCH 800, MONARCH 700, MOGUL (registered Japanese trademark) L, REGAL(registered Japanese trademark) 400R, REGAL 660R, and REGAL 330R each produced by Cabot Corporation. Still other examples of the commercially available carbon black include MITSUBISHI (registered Japanese trademark) CARBON BLACK #2300, MITSUBISHI CARBON BLACK #980, MITSUBISHI CARBON BLACK #970, MITSUBISHI CARBON BLACK #960, MITSUBISHI CARBON BLACK #950, MITSUBISHI CARBON BLACK #900, MITSUBISHI CARBON BLACK #850, MITSUBISHI CARBON BLACK MCF88, MITSUBISHI CARBON BLACK MA600, MITSUBISHI CARBON BLACK #52, MITSUBISHI CARBON BLACK #47, MITSUBISHI CARBON BLACK #45, MITSUBISHI CARBON BLACK #40, MITSUBISHI CARBON BLACK #33, MITSUBISHI CARBON BLACK #25, MITSUBISHI CARBON BLACK MA7, MITSUBISHI CARBON BLACK MA8, and MITSUBISHI CARBON BLACK MA100 each produced by Mitsubishi Chemical Corporation. Still other examples of the commercially available carbon black include COLOUR BLACK FW 1, COLOUR BLACK FW 2, COLOUR BLACK FW 200, COLOUR BLACK FW 18, SPECIAL BLACK 6, COLOUR BLACK S 160, SPECIAL BLACK 5, PRINTEX (registered Japanese trademark) U, PRINTEX V, SPECIAL BLACK 4, SPECIAL BLACK 4A, PRINTEX 140 U, PRINTEX 140 V, and PRINTEX 35 each produced by Orion Engineered Carbons.

Examples of the cyan pigments include C.I. Pigment Blue 1, C.I. Pigment Blue 2, C.I. Pigment Blue 3, C.I. Pigment Blue 15:3, C.I. Pigment Blue 15:4, C.I. Pigment Blue 16, C.I. Pigment Blue 22, C.I. Vat Blue 4, and C.I. Vat Blue 6.

Examples of the magenta pigments include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 146, C.I. Pigment Red 168, C.I. Pigment Red 184, C.I. Pigment Red 202, and C.I. Pigment Violet 19.

Examples of the yellow pigments include C.I. Pigment Yellow 12, C.I. Pigment Yellow 13, C.I. Pigment Yellow 14, C.I. Pigment Yellow 17, C.I. Pigment Yellow 74, C.I. Pigment Yellow 83, C.I. Pigment Yellow 93, C.I. Pigment Yellow 94, C.I. Pigment Yellow 95, C.I. Pigment Yellow 120, C.I. Pigment Yellow 128, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Examples of the white pigments include C.I. Pigment White 4, C.I. Pigment White 5, C.I. Pigment White 6, C.I. Pigment White 6:1, C.I. Pigment White 7, C.I. Pigment White 18, C.I. Pigment White 19, C.I. Pigment White 20, C.I. Pigment White 21, C.I. Pigment White 23, C.I. Pigment White 24, C.I. Pigment White 25, C.I. Pigment White 26, C.I. Pigment White 27, and C.I. Pigment White 28.

Examples of the additional pigments include C.I. Pigment Green 7, C.I. Pigment Green 10, C.I. Pigment Green 36, C.I. Pigment Brown 3, C.I. Pigment Brown 5, C.I. Pigment Brown 25, C.I. Pigment Brown 26, C.I. Pigment Orange 2, C.I. Pigment Orange 5, C.I. Pigment Orange 7, C.I. Pigment Orange 13, C.I. Pigment Orange 14, C.I. Pigment Orange 15, C.I. Pigment Orange 16, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 62, C.I. Pigment Orange 63, C.I. Pigment Orange 64, and C.I. Pigment Orange 71.

From the viewpoint of ensuring ejection performance of the ink in ejection from each recording head, the pigment preferably has a percentage content of at least 0.1% by mass and no greater than 15% by mass relative to the mass of the ink.

Preferably, the pigment is used in a state of being dispersed in a dispersion medium (e.g., water). No particular limitations are placed on a method for dispersing the pigment, and examples of the method include a method in which the pigment is dispersed in a dispersion medium using a dispersant and a method in which the pigment is dispersed in a dispersion medium without using a dispersant. The pigment is preferably a pigment (non self-dispersing pigment) dispersed in a dispersion medium with a dispersant. Examples of the dispersant include a surfactant and a macromolecular dispersant (also referred to below as “pigment dispersion resin”). Note that the surfactant will be described later.

The pigment dispersion resin attaches to the surfaces of pigment particles to disperse the pigment particles in the ink. Note that a portion of the pigment dispersion resin may not attach to the surfaces of the pigment particles and be free in the ink. Examples of the pigment dispersion resin include acrylic resin, styrene-(meth)acrylic resin, styrene-maleic acid resin, and urethane resin. From the viewpoint of stable dispersion of the pigment, the pigment dispersion resin is preferably (meth)acrylic resin or styrene-(meth)acrylic resin.

The pigment dispersion resin has a mass average molecular weight of preferably at least 5000 and no greater than 100,000, more preferably at least 10,000 and no greater than 50,000, and further preferably at least 15,000 and no greater than 30,000. As a result of the mass average molecular weight of the pigment dispersion resin being set to at least 5000, dispersion stability of the ink increases. As a result of the mass average molecular weight of the pigment dispersion resin being set to no greater than 100,000, ejection performance of the ink in ejection from each recording head is improved.

The ratio of the mass of the pigment dispersion resin to the mass of the pigment is preferably at least 0.02 and no greater than 0.45, more preferably at least 0.04 and no greater than 0.40, and further preferably at least 0.05 and no greater than 0.35. As a result of the ratio of the mass of the pigment dispersion resin to the mass of the pigment is no greater than 0.45, each viscosity of the pigment dispersion and the ink can be easily adjusted to a desired value. As a result of the ratio of the mass of the pigment dispersion resin to the mass of the pigment being set to at least 0.02, dispersion stability of the ink increases.

The pigment dispersion resin may be a commercially available pigment dispersion resin. Examples of the commercially available pigment dispersion resin include: JONCRYL (registered Japanese trademark) 586 and JONCRYL 611 each produced by BASF Japan Ltd.; DISPERBYK (registered Japanese trademark)-190 and DISPERBYK-191 each produced by BYK Chemie Japan, K.K.; and SOLSPERSE 20000 and SOLSPERSE 27000 each produced by Lubrizol Japan Limited.

(Binder Resin)

From the viewpoint of obtaining images with excellent scratch resistance, the ink preferably contains binder resin. The binder resin binds a recording medium and the pigment in the ink to each other after ink landing. As a result of the ink containing binder resin, the pigment and a recording medium heated by the heater can be favorably bound to each other, the ink can hardly bleed in a formed image, and color mixing of the inks in image formation can be inhibited.

The binder resin is a water-insoluble resin, for example. No particular limitations are placed on the binder resin, and examples of the binder resin include urethane resin, (meth)acrylic resin, styrene-(meth)acrylic resin, (meth)acryl-urethane resin, polyester resin, and modified polyolefin resin. The binder resin is preferably urethane resin, (meth)acrylic resin, or styrene-(meth)acrylic resin.

Preferably, the water-insoluble resin is used in a state of resin emulsion. Where the water-insoluble resin in a state of resin emulsion is used, the ink contains emulsified particles constituted by the water-insoluble resin. The resin emulsion may be a commercially available resin emulsion.

No particular limitations are placed on the urethane resin and any urethane resin with a urethane bond in its molecules can be used. Examples of a commercially available emulsion of urethane resin include: SUPERFLEX (registered Japanese trademark) 170, SUPERFLEX 210, SUPERFLEX 820, and SUPERFLEX 870 each produced by DKS Co. Ltd.; and TAKELAC (registered Japanese trademark) W-6010 and TAKELAC W-6020 each produced by Mitsui Chemicals, Inc.

Examples of a commercially available emulsion of (meth)acrylic resin include MOWINYL (registered Japanese trademark) 6718, MOWINYL 6751D, MOWINYL 6750, MOWINYL 6760, MOWINYL 6770, MOWINYL 6800, MOWINYL 6969D, MOWINYL 6899D, and MOWINYL 6820 each produced by Japan Coating Resin Corporation.

Examples of a commercially available emulsion of styrene-(meth)acrylic resin include: MOWINYL 6960, MOWINYL 6963, and MOWINYL RS-009C22 each produce by Japan Coating Resin Corporation; and QE-1042 produced by SEIKO PMC CORPORATION.

From the viewpoint of ensuring ejection performance of the ink in ejection from each recording head, the binder resin preferably has a percentage content of at least 1% by mass and no greater than 10% by mass relative to the mass of the ink.

(Surfactant)

The ink may contain a surfactant. Examples of the surfactant include an acetylene-based surfactant, an acryl-based surfactant, a silicone-based surfactant, and a fluorine-based surfactant. The surfactant may be a commercially available surfactant.

In the present specification, the acetylene-based surfactant means a surfactant having an acetylene bond (carbon atom triple bond) in its molecules. Examples of a commercially available acetylene-based surfactant include SURFYNOL (registered Japanese trademark) 420, SURFYNOL 440, OLFINE (registered Japanese trademark) E1010, OLFINE EXP. 4200, and OLFINE EXP. 4300 each produced by Nissin Chemical Industry Co., Ltd.

In the present specification, the acryl-based surfactant is a surfactant of a polymer of (meth)acrylic acid or a derivative thereof. Examples of a commercially available acryl-based surfactant include: BYK (registered Japanese trademark)-380 N and BYK-381 each produced by BYK Chemie Japan, K.K.; and POLYFLOW KL-850 produced by Kyoeisha Chemical Co., Ltd.

In the present specification, the silicone-based surfactant refers to a surfactant having a siloxane bond in its molecules. Examples of a commercially available silicone-based surfactant include SILFACE (registered Japanese trademark) SAG002 and SILFACE SAG503A each produced by Nissin Chemical Industry Co., Ltd.

In the present specification, the fluorine-based surfactant means a surfactant having a fluoro group in its molecules. Examples of a commercially available fluorine-based surfactant include CAPSTONE FS-30, CAPSTONE FS-31, CAPSTONE FS-65, and CAPSTONE FS-3100 each produced by Chemours.

From the viewpoint of ensuring ejection performance of the ink in ejection from each recording head, the surfactant is preferably an acetylene-based surfactant or an acryl-based surfactant.

The percentage content of the surfactant is preferably at least 0.05% by mass and no greater than 2% by mass relative to the mass of the ink. As a result of the percentage content of the surfactant being set within the above range, the dynamic surface tension of the ink can be easily adjusted to within a range suitable for inkjet recording.

(Additional Component)

The ink may contain an additional component. Examples of the additional component include a pH adjuster, a chelating agent, a preservative, and an antifungal agent. No particular limitations are placed on the percentage content of the additional component, and the percentage content of the additional component may be set as appropriate according to necessity.

(Viscosity and Dynamic Surface Tension of Ink)

From the viewpoint of ensuring ejection performance of the ink in ejection from each recording head, the ink has a viscosity at 25° C. of preferably at least 4 mPa·s and no greater than 10 mPa·s, and more preferably at least 5 mPa·s and no greater than 9 mPa·s.

From the viewpoint of ensuring consecutive ejection performance of the ink in ejection from each recording head, the ink has a dynamic surface tension of preferably at least 30 mN/m and no greater than 40 mN/m. As a result of the dynamic surface tension of the ink being set to at least 30 mN/m, consecutive ejection performance of the ink in ejection from each recording head in high-speed printing is improved.

(Pigment Dispersion Production Method)

No particular limitations are placed on a method for producing the pigment dispersion, and an example of the method is mixing the pigment, water, and a dispersant added as necessary using a disperser.

No particular limitations are placed on the disperser, and the disperser may be a ball mill or a bead mill, for example. Of the mills, the bead mill is preferably used. Examples of the bead mill include ATTRITOR (registered Japanese trademark) produced by Nippon Coke & Engineering Co., Ltd., a sand grinder produced by Aimex Co. Ltd., DYNO (registered Japanese trademark) MILL produced by Willy A. Bachofen AG, and an ultra-apex mill produced by METAL & MACHINERY CO., LTD.

In a case in which coarse particles are contained in the resultant pigment dispersion, the coarse particles are preferably removed by filtration or centrifugation. Removal of the coarse particles can prevent clogging in the discharge ports of each recording head.

(Ink Production Method)

For example, a method for producing the ink includes mixing a pigment dispersion containing the pigment, the cellulose derivative, the first water-soluble organic solvent, the second water-soluble organic solvent, and water. At least one selected from the group consisting of the binder resin, the surfactant, and the additional component may be further added and mixed according to necessity. The method for producing the ink may further include removing an insoluble substance by filtration.

As has been described previously, the ink can be inhibited from bleeding in printing on the specific recording medium. Therefore, the ink can be favorably used for printing on the specific recording medium. The ink used in the inkjet recording apparatus according to the first embodiment and the inkjet recording method according to the second embodiment has been described so far.

### Examples

The following provides further specific description of the present disclosure through use of Examples. However, the present disclosure is not limited to Examples.

<Production of Cyan Pigment Dispersion>

First of all, a cyan pigment dispersion for ink production was produced. Using a disperser, 15 parts by mass of a cyan pigment (C.I. Pigment Blue 15:3, product of BASF Japan Ltd., “HELIOGEN (registered Japanese trademark) Blue D 7088”), 10 parts by mass of a pigment dispersion resin (product of BYK Chemie Japan, K.K., product name: DISPERBYK-190, nonvolatile content: 40% by mass, dispersion medium: water), and 75 parts by mass of water were pre-dispersed by mixing to yield a pre-dispersion. Next, the pre-dispersion was further dispersed using a bead mill (product of Willy A. Bachofen AG, “DNYNO (registered Japanese trademark) MILL”) in which zirconia beads with a diameter of 0.3 mm have been loaded to obtain a cyan pigment dispersion.

<Production of Black Pigment Dispersion>

A black pigment dispersion was obtained according to the same method as that for producing the cyan pigment dispersion in all aspects other than change of the cyan pigment to a black pigment (product of Orion Engineered Carbons, “PRINTEX (registered Japanese trademark) 85”).

<Cyan Ink Production>

Next, cyan inks (A1-1) to (A9-1) of Examples and cyan inks (B1-1) to (B6-1) of Comparative Examples were produced. Compositions of these cyan inks are shown below in Tables 1 to 5.

(Production of Cyan Ink (A1-1))

Using a stirrer, respective components were mixed to achieve the composition shown in the column titled (A1-1) for cyan ink in Table 1 to yield a mixture. Specifically, the mixture was obtained by mixing 20.00 parts by mass of the cyan pigment dispersion, 0.05 parts by mass of sodium carboxymethylcellulose, 10.00 parts by mass of propylene glycol monomethyl ether, 20.00 parts by mass of 1,2-propanediol, 10.00 parts by mass of a water-insoluble resin emulsion (product of DKS Co. Ltd., “SUPERFLEX 870”), 0.40 parts by mass of a surfactant (product of Nissin Chemical Industry Co., Ltd., “SURFYNOL (registered Japanese trademark) 440”), the remaining amount (39.55 parts by mass) of ion exchange water. The mixture was filtered using a membrane filter with an opening of 5 μm to obtain a cyan ink (A1-1).

(Production of Cyan Inks (A2-1) to (A9-1) and (B1-1) to (B6-1))

Cyan inks (A2-1) to (A9-1) and (B1-1) to (B6-1) were produced according to the same method as that for producing the cyan ink (A1-1) in all aspects other than that respective components were mixed to achieve the compositions shown in the columns titled (A2-1) to (A9-1) and (B1-1) to (B6-1) for cyan ink in Tables 1 to 5.

<Black Ink Production>

Next, black inks (A1-2) to (A9-2) of Examples and black inks (B1-2) to (B6-2) of Comparative Examples were produced. The compositions of these black inks are shown below in Tables 1 to 5.

The black inks (A1-2) to (A9-2) and (B1-2) to (B6-2) were produced according to the same method as that for producing the cyan ink (A1-1) in all aspects other than that respective components were mixed to achieve the compositions shown in the columns titled (A1-2) to (A9-2) and (B1-2) to (B6-2) for black ink in Tables 1 to 5.

[Evaluation]

With respect to each of the inks (A1-1) to (A9-2) and (B1-1) to (B6-2), the following evaluations were carried out in a normal-temperature and normal-humidity environment (environment at a temperature of 25° C. and a relative humidity of 60%). An inkjet recording apparatus (prototype produced by KYOCERA Document Solutions Japan Inc.) including a line recording head was used as an evaluation apparatus. The evaluation apparatus included a temperature sensor, a wiping blade, and a heater that performs preheating. The distance between the heater and a recording medium is 0 mm (in contact with each other). The distance between the temperature sensor and the recording medium is 5 mm. The distance between a heated point and a temperature sensed point on the recording medium is 10 mm. The distance between the temperature sensed point and an ejection point on the recording medium is 10 mm. One of the cyan inks obtained in <Cyan Ink Production> described above was charged into an ink tank for cyan color of the evaluation apparatus. One of the black inks obtained in <Black Ink Production> described above was charged into an ink tank for black color of the evaluation apparatus. The preheating temperature was set to a corresponding temperature shown in Tables 1 to 5. The conveyance speed of the recording medium is set to 50 m/min.

<Evaluation of Ejection Performance>

Using the evaluation apparatus, a solid image was consecutively printed on 100 sheets of a recording medium (synthetic paper, product of YUPO CORPORATION, “NEW YUPO FGS”). After the printing, purging and wiping were performed. The purging was an operation of pressurizing the ink to eject the ink from discharge ports formed in the ejection surface of the recording head. The wiping is an operation of wiping the ejection surface of the recording head using the wiping blade. Next, an image for nozzle check was printed on one sheet of the recording medium and confirmed that the ink was ejected from all of the discharge ports. Next, purging and wiping were performed again. Next, the evaluation apparatus was left to stand for 8 hours without performing capping (operation of sealing the discharge ports with rubber caps). After the 8-hour leaving, purging and wiping were performed again. Next, an image for nozzle check was printed on one sheet of the recording medium to obtain an evaluation image. Through observation of the evaluation image, the number of discharge ports from which the ink had not been ejected (i.e., the number of discharge ports in which nozzle clogging had occurred) was counted. Ejection performance of the ink in ejection from the recording head was evaluated according to the following criteria. Evaluation results are shown in Tables 1 to 5.

(Evaluation Criteria of Ejection performance)

A (good): the number of discharge ports in which nozzle clogging had occurred of less than 10% by number

B (poor): the number of discharge ports in which nozzle clogging had occurred of at least 10% by number

<Evaluation of Color Mixing Inhibition>

Using the evaluation apparatus, an image was printed on one sheet of a recording medium (specifically, one of the following specific recording mediums I to III) to obtain an evaluation image. The image was a cross image of a rectangular solid black image parallel to the longitudinal direction of the recording medium and a rectangular solid cyan image parallel to the width direction of the recording medium. An area of the evaluation image where the solid images crossed had a size of 5 mm long and 5 mm wide. A width (overhang width) by which one of the color inks has bled to an image area of the other ink was measured in the area where the solid images crossed in the evaluation image. Overhang widths were measured at 5 locations and a number average of the measured overhang widths (average of overhang widths) was calculated. Color mixing inhibition of the inks was evaluated according to the following criteria. Evaluation results are shown in Tables 1 to 5.

Specific recording medium I: synthetic paper (product of YUPO CORPORATION, product name: NEW YUPO FGS, paper thickness: 80 μm)

Specific recording medium II: cast coated paper (product of Oji Paper Co., Ltd., product name; MIRRORKOTE (registered Japanese trademark) GOLD, paper thickness: 88 μm)

Specific recording medium III: PET film (product of Toray Industries, Inc., product name: POLYESTER FILM LUMIRROR (registered Japanese trademark) S10 #50)

(Evaluation Criteria of Color Mixing Inhibition)

A (very good): the average of overhang widths was less than 150 μm and no color mixing was not observed.

B (good): the average of overhang widths was at least 150 μm and less than 300 μm and no practical problems were involved although slight color mixing was observed.

C (poor): the average of overhang widths was at least 300 μm and apparent color mixing was observed.

Note that the terms in Tables 1 to 5 mean as follows.

Ink: cyan ink or black ink

CMC-Na: sodium carboxymethylcellulose (product of Daicel Miraizu Ltd., product name: CMC DAICEL 1330, degree of etherification: 1.3)

Resin emulsion: emulsion of urethane resin being water-insoluble resin (product of DKS Co. Ltd., product name: SUPERFLEX 870, nonvolatile content: 30% by mass, dispersion medium: water)

Surfactant: acetylene-based surfactant (product of Nissin Chemical Industry Co., Ltd., product name: SURFYNOL (registered Japanese trademark) 440, effective concentration: 100% by mass)

Water: ion exchange water

Rest: being an amount that made the total mass of the components in the corresponding ink 100.00 parts by mass (e.g., the amount of water contained in the ink (A1-1) is 39.55 parts by mass (=100.00−(20.00+0.05+10.00+20.00+10.00+0.40)))

-: no containtment of a corresponding component

GE percent content: percentage content (unit: % by mass) of glycol ether relative to the total mass of the first water-soluble organic solvent (glycol ether) and the second water-soluble organic solvent

YUPO: specific recording medium I

Cast coated paper: specific recording medium II

PET: specific recording medium III

NG: being poor

Repelling: image printing being disabled due to ink repelling on recording medium

“None” in column titled “Preheating temperature”: no heating being performed by turning off heater.

Furthermore, the respective components had been added so that 100.00 parts by mass of the corresponding ink was obtained. Therefore, the amount (unit: part by mass) of each component shown in the column titled “Composition” in Tables 1 to 5 corresponds to the percentage content (unit: % by mass) of the component relative to the mass of the corresponding ink. For example, each amount (unit: part by mass) shown in the column titled “CMC-Na” in Tables 1 to 5 corresponds to the percentage content (unit: % by mass) of the cellulose derivative relative to the mass of the corresponding ink. Furthermore, each amount (unit: part by mass) of glycol ethers shown in Tables 1 to 5, that is, the total amount of the amounts shown in columns titled “Propylene glycol monomethyl ether”, “Propylene glycol monopropyl ether”, “Dipropylene glycol monomethyl ether”, “Dipropylene glycol monopropyl ether”, and “Triethylene glycol monobutyl ether” corresponds to the percentage content (unit: % by mass) of the glycol ether relative to the mass of the corresponding ink.

TABLE 1

| | | Example 1 | | Example 2 | | Example 3 | |
|---|---|---|---|---|---|---|---|
| Ink | | A1-1 | A1-2 | A2-1 | A2-2 | A3-1 | A3-2 |
| Composition | Cyan pigment dispersion | 20.00 | — | 20.00 | — | 20.00 | — |
| [part by mass] | Black pigment dispersion | — | 20.00 | — | 20.00 | — | 20.00 |
| | CMC-Na | 0.05 | 0.05 | 0.10 | 0.10 | 0.05 | 0.05 |
| | Propylene glycol monomethyl ether | 10.00 | 10.00 | 10.00 | 10.00 | — | — |
| | Propylene glycol monopropyl ether | — | — | — | — | 10.00 | 10.00 |
| | Dipropylene glycol monomethyl ether | — | — | — | — | — | — |
| | Dipropylene glycol monopropyl ether | — | — | — | — | — | — |
| | Triethylene glycol monobutyl ether | — | — | — | — | — | — |
| | 1,2-Propanediol | 20.00 | 20.00 | 20.00 | 20.00 | — | — |
| | 3-Methyl-1,3-butanediol | — | — | — | — | 20.00 | 20.00 |
| | 1,2-Pentanediol | — | — | — | — | — | — |
| | 2-Methyl-1,3-propanediol | — | — | — | — | — | — |
| | 1,3-Propanediol | — | — | — | — | — | — |
| | 1,5-Pentanediol | — | — | — | — | — | — |
| | 3-Methyl-1,5-pentanediol | — | — | — | — | — | — |
| | Resin emulsion | 10.00 | 10.00 | 10.00 | 10.00 | 10.00 | 10.00 |
| | Surfactant | 0.40 | 0.40 | 0.40 | 0.40 | 0.40 | 0.40 |
| | Water | Rest | Rest | Rest | Rest | Rest | Rest |
| | Total | 100.00 | 100.00 | 100.00 | 100.00 | 100.00 | 100.00 |

| | | | | | | |
|---|---|---|---|---|---|---|
| GE percentage content [% by mass] | 33 | 33 | 33 | 33 | 33 | 33 |

| Preheating temperature [° C.] | | 50 | 50 | 50 |
|---|---|---|---|---|
| Ejection performance | | A | A | A |
| Color | YUPO | A | A | A |
| mixing | Cast coated paper | A | A | A |
| inhibition | PET | A | A | A |

TABLE 2

| | | Example 4 | | Example 5 | | Example 6 | |
|---|---|---|---|---|---|---|---|
| Ink | | A4-1 | A4-2 | A5-1 | A5-2 | A6-1 | A6-2 |
| Composition | Cyan pigment dispersion | 20.00 | — | 20.00 | — | 20.00 | — |
| [part by mass] | Black pigment dispersion | — | 20.00 | — | 20.00 | — | 20.00 |
| | CMC-Na | 0.05 | 0.05 | 0.05 | 0.05 | 0.05 | 0.05 |
| | Propylene glycol monomethyl ether | — | — | — | — | — | — |
| | Propylene glycol monopropyl ether | — | — | — | — | — | — |
| | Dipropylene glycol monomethyl ether | 10.00 | 10.00 | — | — | — | — |
| | Dipropylene glycol monopropyl ether | — | — | 10.00 | 10.00 | — | — |
| | Triethylene glycol monobutyl ether | — | — | — | — | 10.00 | 10.00 |
| | 1,2-Propanediol | — | — | — | — | — | — |
| | 3-Methyl-1,3-butanediol | — | — | — | — | — | — |
| | 1,2-Pentanediol | 20.00 | 20.00 | — | — | — | — |
| | 2-Methyl-1,3-propanediol | — | — | 20.00 | 20.00 | — | — |
| | 1,3-Propanediol | — | — | — | — | 20.00 | 20.00 |
| | 1,5-Pentanediol | — | — | — | — | — | — |
| | 3-Methyl-1,5-pentanediol | — | — | — | — | — | — |
| | Resin emulsion | 10.00 | 10.00 | 10.00 | 10.00 | 10.00 | 10.00 |
| | Surfactant | 0.40 | 0.40 | 0.40 | 0.40 | 0.40 | 0.40 |
| | Water | Rest | Rest | Rest | Rest | Rest | Rest |
| | Total | 100.00 | 100.00 | 100.00 | 100.00 | 100.00 | 100.00 |

| | | | | | | |
|---|---|---|---|---|---|---|
| GE percentage content [% by mass] | 33 | 33 | 33 | 33 | 33 | 33 |

| Preheating temperature [° C.] | | 50 | 50 | 50 |
|---|---|---|---|---|
| Ejection performance | | A | A | A |
| Color mixing | YUPO | A | A | A |
| inhibition | Cast coated paper | A | A | A |
| | PET | A | A | A |

TABLE 3

| | | Example 7 | | Example 8 | | Example 9 | |
|---|---|---|---|---|---|---|---|
| Ink | | A7-1 | A7-2 | A8-1 | A8-2 | A9-1 | A9-2 |
| Composition | Cyan pigment dispersion | 20.00 | — | 20.00 | — | 20.00 | — |
| [part by mass] | Black pigment dispersion | — | 20.00 | — | 20.00 | — | 20.00 |
| | CMC-Na | 0.05 | 0.05 | 0.05 | 0.05 | 0.05 | 0.05 |
| | Propylene glycol monomethyl ether | 24.00 | 24.00 | — | — | 10.00 | 10.00 |
| | Propylene glycol monopropyl ether | — | — | 24.00 | 24.00 | — | — |
| | Dipropylene glycol monomethyl ether | — | — | — | — | — | — |
| | Dipropylene glycol monopropyl ether | — | — | — | — | — | — |
| | Triethylene glycol monobutyl ether | — | — | — | — | — | — |
| | 1,2-Propanediol | — | — | — | — | 20.00 | 20.00 |
| | 3-Methyl-1,3-butanediol | — | — | — | — | — | — |
| | 1,2-Pentanediol | — | — | — | — | — | — |
| | 2-Methyl-1,3-propanediol | — | — | — | — | — | — |
| | 1,3-Propanediol | — | — | — | — | — | — |
| | 1,5-Pentanediol | 6.00 | 6.00 | — | — | — | — |
| | 3-Methyl-1,5-pentanediol | — | — | 6.00 | 6.00 | — | — |
| | Resin emulsion | 10.00 | 10.00 | 10.00 | 10.00 | 10.00 | 10.00 |
| | Surfactant | 0.40 | 0.40 | 0.40 | 0.40 | 0.40 | 0.40 |
| | Water | Rest | Rest | Rest | Rest | Rest | Rest |
| | Total | 100.00 | 100.00 | 100.00 | 100.00 | 100.00 | 100.00 |

| | | | | | | |
|---|---|---|---|---|---|---|
| GE percentage content [% by mass] | 80 | 80 | 80 | 80 | 33 | 33 |

| Preheating temperature [° C.] | | 50 | 50 | 70 |
|---|---|---|---|---|
| Ejection performance | | A | A | A |
| Color mixing | YUPO | A | A | A |
| inhibition | Cast coated paper | A | A | A |
| | PET | A | A | A |

TABLE 4

| | | Comparative | | Comparative | | Comparative | |
|---|---|---|---|---|---|---|---|
| | | Example 1 | | Example 2 | | Example 3 | |
| Ink | | B1-1 | B1-2 | B2-1 | B2-2 | B3-1 | B3-2 |
| Composition | Cyan pigment dispersion | 20.00 | — | 20.00 | — | 20.00 | — |
| [part by mass] | Black pigment dispersion | — | 20.00 | — | 20.00 | — | 20.00 |
| | CMC-Na | 0.05 | 0.05 | 0.05 | 0.05 | — | — |
| | Propylene glycol monomethyl ether | 10.00 | 10.00 | 10.00 | 10.00 | 10.00 | 10.00 |
| | Propylene glycol monopropyl ether | — | — | — | — | — | — |
| | Dipropylene glycol monomethyl ether | — | — | — | — | — | — |
| | Dipropylene glycol monopropyl ether | — | — | — | — | — | — |
| | Triethylene glycol monobutyl ether | — | — | — | — | — | — |
| | 1,2-Propanediol | 20.00 | 20.00 | 20.00 | 20.00 | 20.00 | 20.00 |
| | 3-Methyl-1,3-butanediol | — | — | — | — | — | — |
| | 1,2-Pentanediol | — | — | — | — | — | — |
| | 2-Methyl-1,3-propanediol | — | — | — | — | — | — |
| | 1,3-Propanediol | — | — | — | — | — | — |
| | 1,5-Pentanediol | — | — | — | — | — | — |
| | 3-Methyl-1,5-pentanediol | — | — | — | — | — | — |
| | Resin emulsion | 10.00 | 10.00 | 10.00 | 10.00 | 10.00 | 10.00 |
| | Surfactant | 0.40 | 0.40 | 0.40 | 0.40 | 0.40 | 0.40 |
| | Water | Rest | Rest | Rest | Rest | Rest | Rest |
| | Total | 100.00 | 100.00 | 100.00 | 100.00 | 100.00 | 100.00 |

| | | | | | | |
|---|---|---|---|---|---|---|
| GE percentage content [% by mass] | 33 | 33 | 33 | 33 | 33 | 33 |

| Preheating temperature [° C.] | | None | 90 | 50 |
|---|---|---|---|---|
| Ejection performance | | A | B (NG) | A |
| Color mixing | YUPO | C (NG) | A | C (NG) |
| inhibition | Cast coated paper | B | A | C (NG) |
| | PET | C (NG) | A | C (NG) |

TABLE 5

| | | Comparative | | Comparative | | Comparative | |
|---|---|---|---|---|---|---|---|
| | | Example 4 | | Example 5 | | Example 6 | |
| Ink | | B4-1 | B4-2 | B5-1 | B5-2 | B6-1 | B6-2 |
| Composition | Cyan pigment dispersion | 20.00 | — | 20.00 | — | 20.00 | — |
| [part by mass] | Black pigment dispersion | — | 20.00 | — | 20.00 | — | 20.00 |
| | CMC-Na | 0.25 | 0.25 | 0.25 | 0.25 | 0.25 | 0.25 |
| | Propylene glycol monomethyl ether | 10.00 | 10.00 | — | — | 27.00 | 27.00 |
| | Propylene glycol monopropyl ether | — | — | — | — | — | — |
| | Dipropylene glycol monomethyl ether | — | — | — | — | — | — |
| | Dipropylene glycol monopropyl ether | — | — | — | — | — | — |
| | Triethylene glycol monobutyl ether | — | — | — | — | — | — |
| | 1,2-Propanediol | 20.00 | 20.00 | 30.00 | 30.00 | 13.00 | 13.00 |
| | 3-Methyl-1,3-butanediol | — | — | — | — | — | — |
| | 1,2-Pentanediol | — | — | — | — | — | — |
| | 2-Methyl-1,3-propanediol | — | — | — | — | — | — |
| | 1,3-Propanediol | — | — | — | — | — | — |
| | 1,5-Pentanediol | — | — | — | — | — | — |
| | 3-Methyl-1,5-pentanediol | — | — | — | — | — | — |
| | Resin emulsion | 10.00 | 10.00 | 10.00 | 10.00 | 10.00 | 10.00 |
| | Surfactant | 0.40 | 0.40 | 0.40 | 0.40 | 0.40 | 0.40 |
| | Water | Rest | Rest | Rest | Rest | Rest | Rest |
| | Total | 100.00 | 100.00 | 100.00 | 100.00 | 100.00 | 100.00 |

| | | | | | | |
|---|---|---|---|---|---|---|
| GE percentage content [% by mass] | 33 | 33 | 0 | 0 | 68 | 68 |

| Preheating temperature [° C.] | | 50 | 50 | 50 |
|---|---|---|---|---|
| Ejection performance | | B (NG) | B (NG) | B (NG) |
| Color | YUPO | A | A | A |
| mixing | Cast coated paper | A | A | A |
| inhibition | PET | A | Repelling | C (NG) |

As shown in Table 4, the recording medium was not heated by the heater in evaluation using the cyan ink (B1-1) and the black ink (B1-2). As such, color mixing inhibition was evaluated as poor when these inks were used.

As shown in Table 4, the preheating temperature exceeded 80° C. in evaluation using the cyan ink (B2-1) and the black ink (B2-2). As such, ejection performance was evaluated as poor for these inks.

As shown in Table 4, the cyan ink (B3-1) and the black ink (B3-2) did not contain any cellulose derivative. As such, color mixing inhibition was evaluated as poor when these inks were used.

As shown in Table 5, the percentage content of the cellulose derivative in each of the cyan ink (B4-1) and the black ink (B4-2) exceeded 0.20% by mass relative to the mass of the ink. As such, ejection performance was evaluated as poor for these inks.

As shown in Table 5, the percentage content of the cellulose derivative in each of the cyan ink (B5-1) and the black ink (B5-2) exceeded 0.20% by mass relative to the mass of the ink. Furthermore, these inks did not contain any glycol ether. As such, ejection performance was evaluated as poor for these inks. In addition, when these inks were used, repelling of each ink occurred on the specific recording medium III.

As shown in Table 5, the percentage content of the cellulose derivative in each of the cyan ink (B6-1) and the black ink (B6-2) exceeded 0.20% by mass relative to the mass of the ink. Furthermore, the percentage content of the glycol ether in each of the inks exceeded 24% by mass relative to the mass of the ink. As such, ejection performance and color mixing inhibition were each evaluated for these inks.

By contrast, as shown in Tables 1 to 3, the cyan inks (A1-1) to (A9-1) and the black inks (A1-2) to (A9-2) each contained at least the cellulose derivative, glycol ether being the first water-soluble organic solvent, and the second water-soluble organic solvent. The cellulose derivative had a percentage content of at least 0.01% by mass and no greater than 0.20% by mass relative to the mass of the ink. The glycol ether had a percentage content of at least 6% by mass and no greater than 24% by mass relative to the mass of the ink. The glycol ether had a percentage content of at least 20% by mass and no greater than 80% by mass relative to the total mass of the first water-soluble organic solvent and the second water-soluble organic solvent. As such, ejection performance and color mixing inhibition were each evaluated as good or very good for these inks.

From the above, it was demonstrated that according to the inkjet recording apparatus and the inkjet recording method of the present disclosure, color mixing of the inks is inhibited even when an image is formed on the specific recording medium and ejection performance of the ink in ejection from each recording head is excellent.

What is claimed is:

1. An inkjet recording apparatus comprising:
a heater configured to heat a recording medium; and
a recording head configured to eject an ink toward the recording medium, wherein
the heater is disposed upstream of the recording head in terms of a conveyance direction of the recording medium,
the recording medium heated by the heater has a temperature of at least 40° C. and no greater than 80° C.,
the ink contains a pigment, a cellulose derivative, a first water-soluble organic solvent, a second water-soluble organic solvent, and water,
the first water-soluble organic solvent is glycol ether,
the second water-soluble organic solvent is a water-soluble organic solvent that is not glycol ether,
the cellulose derivative has a percentage content of at least 0.01% by mass and no greater than 0.20% by mass relative to a mass of the ink,
the glycol ether has a percentage content of at least 6% by mass and no greater than 24% by mass relative to the mass of the ink, and
the glycol ether has a percentage content of at least 20% by mass and no greater than 80% by mass relative to a total mass of the first water-soluble organic solvent and the second water-soluble organic solvent.

2. The inkjet recording apparatus according to claim 1, wherein
the cellulose derivative is sodium salt of carboxymethylcellulose.

3. The inkjet recording apparatus according to claim 1, wherein
the glycol ether is at least one selected from the group consisting of propylene glycol monomethyl ether, propylene glycol monopropyl ether, dipropylene glycol monomethyl ether, dipropylene glycol monopropyl ether, and triethylene glycol monobutyl ether.

4. The inkjet recording apparatus according to claim 1, wherein
the second water-soluble organic solvent is at least one selected from the group consisting of 1,2-propanediol, 3-methyl-1,3-butanediol, 1,2-pentanediol, 2-methyl-1,3-propanediol, 1,3-propanediol, 1,5-pentanediol, and 3-methyl-1,5-pentanediol.

5. The inkjet recording apparatus according to claim 1, wherein
the recording medium is conveyed at a speed of at least 20 m/min. and no greater than 100 m/min.

6. An inkjet recording method comprising:
heating a recording medium; and
ejecting an ink toward the recording medium, wherein
the recording medium is heated before the ink is ejected toward the recording medium,
the heated recording medium has a temperature of at least 40° C. and no greater than 80° C.,
the ink contains a pigment, a cellulose derivative, a first water-soluble organic solvent, a second water-soluble organic solvent, and water,
the first water-soluble organic solvent is glycol ether,
the second water-soluble organic solvent is a water-soluble organic solvent that is not glycol ether,
the cellulose derivative has a percentage content of at least 0.01% by mass and no greater than 0.20% by mass relative to a mass of the ink,
the glycol ether has a percentage content of at least 6% by mass and no greater than 24% by mass relative to the mass of the ink, and
the glycol ether has a percentage content of at least 20% by mass and no greater than 80% by mass relative to a total mass of the first water-soluble organic solvent and the second water-soluble organic solvent.
